(19) United States
(12) Patent Application Publication
(10) Pub. No.: US 2016/0259359 A1
(43) Pub. Date: Sep. 8, 2016

(54) VOLTAGE LEVEL CONTROL CIRCUIT AND SEMICONDUCTOR SYSTEM

(71) Applicant: SK hynix Inc., Icheon-si Gyeonggi-do (KR)

(72) Inventors: Seung Chan KIM, Yongin-si Gyeonggi-do (KR); Hyeng Ouk LEE, Yongin-si Gyeonggi-do (KR)

(21) Appl. No.: 14/728,288

(22) Filed: Jun. 2, 2015

(30) Foreign Application Priority Data
Mar. 2, 2015 (KR) 10-2015-0029346

(51) Int. Cl. G05F 3/16

(52) U.S. Cl. CPC G05F 3/16

(57) ABSTRACT

A semiconductor system may include a controller configured to output data and first and second test mode signals. The controller may be configured to count the output of the first and second test mode signals. The semiconductor system may include a voltage level control circuit configured to include a resistor group, and to compare the data with the reference voltage and generate internal data. The resistors of the resistor group having integer multiples of resistances are connected in series to generate the reference voltage, the reference voltage voltage-divided from a power supply voltage by a resistance value of the resistor group controlled according to a combination of the first and second test mode signals.

### CROSS-REFERENCE TO RELATED APPLICATION

The present application claims priority under 35 U.S.C. §119(a) to Korean application number 10-2015-0029346, filed on Mar. 2, 2015, in the Korean Intellectual Property Office, which is incorporated herein by reference in its entirety.

### BACKGROUND

1. Technical Field

Various embodiments generally relate to a semiconductor system, and more particularly, to a voltage level control circuit and a semiconductor system including a voltage level control circuit.

2. Related Art

Circuits included in a semiconductor device may transmit and receive digital signals including data. After receiving a digital signal a circuit may compare the level of the digital signal with a reference voltage through an input buffer including a differential amplifier-type comparator. The circuit may then determine whether the digital signal is at a logic high level or logic low level.

The reference voltage is set to an intermediate value between an electric potential defining a logic high level and an electric potential defining a logic low level. The reference voltage serves as an absolute voltage for determining the logic level of the inputted digital signal.

Generally, a semiconductor memory device generating a reference voltage VREF operates in such a manner as to select one of multiple levels generated through voltage division by a plurality of resistance elements, as a level of the reference voltage VREF.

Also, since the level of a reference voltage VREF generated in a semiconductor device varies depending on changes in the process voltage and temperature (PVT), an operation for controlling the level of a reference voltage VREF according to changes in the process voltage and temperature (PVT) is required.

### SUMMARY

In an embodiment, there may be provided a semiconductor system. The semiconductor system may include a controller configured to output data and first and second test mode signals. The controller may be configured to count the output of the first and second test mode signals. The semiconductor system may include a voltage level control circuit configured to include a resistor group, and to compare the data with the reference voltage and generate internal data. The resistors of the resistor group having integer multiples of resistances are connected in series to generate the reference voltage, the reference voltage voltage-divided from a power supply voltage by a resistance value of the resistor group controlled according to a combination of the first and second test mode signals.

In an embodiment, there may be provided a semiconductor system. The semiconductor system may include a controller configured to output a test enable signal and data. The semiconductor system may include a voltage level control circuit configured to include a resistor group, the resistor group including resistors connected in series and having integer multiples of resistances, to generate a reference voltage, the reference voltage voltage-divided from a power supply voltage by a resistance value of the resistor group controlled by the number of input times of the test enable signal to the voltage level control circuit, and to compare the data with the reference voltage to generate internal data.

In an embodiment, there may be provided a semiconductor system. The semiconductor system may include a controller configured to output a test enable signal. The semiconductor system may include a temperature sensor configured to detect an internal temperature and to generate a temperature detection voltage. The semiconductor system may include a voltage level control circuit configured to include a resistor group, the resistor group including resistors connected in series and having integer multiples of resistances, to generate a reference voltage, the reference voltage voltage-divided from a power supply voltage by a resistance value of the resistor group controlled by the number of input times of the test enable signal to the voltage level control circuit, and to compare the temperature detection voltage with the reference voltage to generate a temperature voltage.

In an embodiment, there may be provided a voltage level control circuit. The voltage level control circuit may include a reference voltage generation unit configured to include a resistor group, the resistor group including resistors connected in series and having integer multiples of resistances, and to generate a reference voltage, the reference voltage voltage-divided from a power supply voltage by a resistance value of the resistor group controlled according to a combination of first and second test mode signals. The voltage level control circuit may include a data input/output unit configured to compare the data with the reference voltage and to generate internal data. The voltage level control circuit may include an internal circuit configured to be supplied with the reference voltage, to be driven, and to store the internal data.

### BRIEF DESCRIPTION OF THE DRAWINGS

FIG. 1 is a configuration diagram illustrating a representation of an example of a semiconductor system in accordance with an embodiment.

FIG. 2 is a circuit diagram illustrating a representation of an example of the configuration of a reference voltage generation unit included in a voltage level control circuit illustrated in FIG. 1.

FIG. 3 is a configuration diagram illustrating a representation of an example of a semiconductor system in accordance with an embodiment.

FIG. 4 is a configuration diagram illustrating a representation of an example of a semiconductor system in accordance with an embodiment.

FIG. 5 illustrates a block diagram of an example of a representation of a system employing a semiconductor system and/or voltage level control circuit in accordance with the various embodiments discussed above with relation to FIGS. 1-4.

### DETAILED DESCRIPTION

Hereinafter, a voltage level control circuits and semiconductor systems will be described below with reference to the accompanying drawings through various examples of embodiments. The embodiments are by way of example only. Accordingly, the scope of protection should not be limited based on the described embodiments.

Various embodiments may be directed to voltage level control circuits and semiconductor systems capable of variously controlling the level of a reference voltage according to a combination of test mode signals.

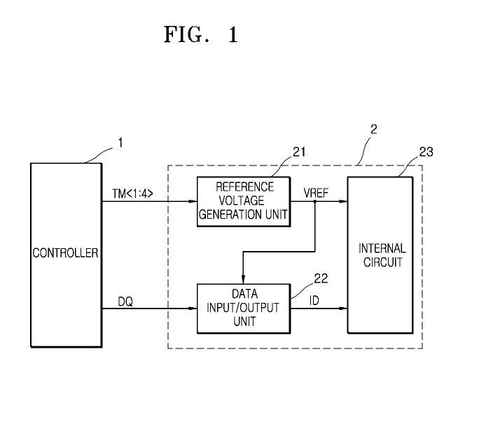

Referring to FIG. 1, in accordance with an embodiment, a semiconductor system may include a controller 1 and a voltage level control circuit 2. The voltage level control circuit 2 may include a reference voltage generation unit 21. The voltage level control circuit 2 may include a data input/output unit 22, and an internal circuit 23.

The controller 1 may output data DQ and first to fourth test mode signals TM<1:4>. The controller 1 may generate and count the first to fourth test mode signals TM<1:4>. For example, the number of bits of the first to fourth test mode signals TM<1:4> are set to be 4 bits, but the number of bits of the test mode signals may be variously set according to the various embodiments.

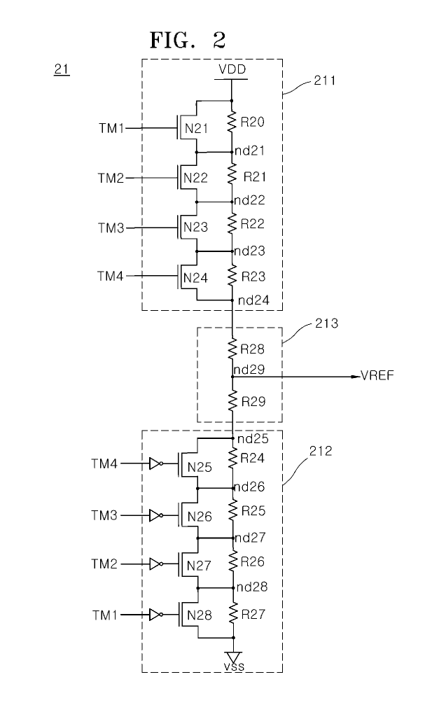

Referring to FIGS. 1 and 2, the reference voltage generation unit 21 may include first and second resistor groups 211 and 212. The first and second resistor groups 211 and 212 may include resistors having integer multiples of resistances, may be serially connected, and may generate a reference voltage VREF. The reference voltage VREF may include a voltage-divided from the power supply voltage VDD by the resistance values of the first and second resistor groups 211 and 212 controlled according to a combination of the first to fourth test mode signals TM<1:4>.

The operation controlling the resistance values of the first and second resistor groups 211 and 212 of FIG. 2 according to a combination of the first to fourth test mode signals TM<1:4> will be described later with reference to the drawings.

The data input/output unit 22 may compare data DQ with the reference voltage VREF and generate internal data ID. For example, the data input/output unit 22 may be configured with a comparator having the form of a differential amplifier. For example, although the data input/output unit 22 is configured to compare data DQ with the reference voltage VREF to generate internal data ID, the data input/output unit 22 may be configured to compare internal data ID with the reference voltage VREF to generate data DQ.

The internal circuit 23 may be driven by receiving the reference voltage VREF, and store internal data ID. For example, the internal circuit 23 may be implemented with a general circuit driven by receiving the reference voltage VREF. For example, although the internal circuit 23 is configured to store internal data ID, the internal circuit 23 may be configured to output internal data ID.

The voltage level control circuit 2 may include first and second resistor groups 211 and 212. The resistors of the first and second resistor groups 211 and 212 having integer multiples of resistances are serially connected, and may generate a reference voltage VREF. The reference voltage VREF may include a voltage-divided from the power supply voltage VDD by a difference of resistance values between the first and second resistor groups 211 and 212 controlled according to a combination of the first to fourth test mode signals TM<1:4>. The voltage level control circuit 2 may compare data DQ with the reference voltage VREF, generate internal data ID, and store the internal data ID.

Referring to FIGS. 1 and 2, the reference voltage generation unit 21 may include, for example, a first resistor group 211, a second resistor group 212, and a third resistor group 213.

The first resistor group 211 may, for example, include: a first resistor R20 positioned between the power supply voltage VDD and node nd21; a second resistor R21 positioned between node nd21 and node nd22; a third resistor R22 positioned between node nd22 and node nd23; a fourth resistor R23 positioned between node nd23 and node nd24; a first switch N21 positioned between the power supply voltage VDD and node nd21, and configured to be turned on and to electrically connect the power supply voltage VDD and node nd21 to each other when the first test mode signal TM<1> is at a logic high level; a second switch N22 positioned between node nd21 and node nd22, and configured to be turned on and to electrically connect node nd21 and node nd22 to each other when the second test mode signal TM<2> is at a logic high level; a third switch N23 positioned between node nd22 and node nd23, and configured to be turned on and to electrically connect node nd22 and node nd23 to each other when the third test mode signal TM<3> is at a logic high level; and a fourth switch N24 positioned between node nd23 and node nd24, and configured to be turned on and to electrically connect node nd23 and node nd24 to each other when the fourth test mode signal TM<4> is at a logic high level. For example, the second resistor R21 may be set to have a resistance value twice that of the first resistor R20, and the third resistor R22 may be set to have a resistance value twice that of the second resistor R21, and the fourth resistor R23 may be set to have a resistance value twice that of the third resistor R22. For example, the resistance values of the first to fourth resistors R20, R21, R22 and R23 have been set to two multiples for convenience of description, and it is preferred that the resistance values are set to integer multiples of one another.

The first to fourth switches N21, N22, N23 and N24 included in the first resistor group 211 may be configured with NMOS transistors, may be configured with PMOS transistors, or with a transmission gate in which NMOS and PMOS transistors are electrically connected according to various embodiments.

For example, an example of an operation in which the resistance value of the first resistor group 211 is controlled according to a combination of the first to fourth test mode signals TM<1:4> will be described below, wherein the example will be described about the example where the resistance value of the first resistor R20 is set to 1 kΩ.

First, the operation in which the resistance value of the first resistor group 211 is controlled when the combination of the first to fourth test mode signals TM<1:4> is “L, L, H, and H” will be described below. For example, the combination “L, L, H, and H” of the first to fourth test mode signals TM<1:4> means that: the first test mode signal TM<1> is at a logic high level “H”; the second test mode signal TM<2> is at a logic high level “H”; the third test mode signal TM<3> is at a logic low level “L”; and the fourth test mode signal TM<4> is at a logic low level “L”.

With respect to the first resistor group 211, when, for example, the combination of the first to fourth test mode signals TM<1:4> is “L, L, H, and H”, the first switch N21 and the second switch N22 are turned on, and the third switch N23 and the fourth switch N24 are turned off. For example, the resistance value of the first resistor group 211 is set to 12 kΩ which is a sum of the resistance values of the third resistor R22 and fourth resistor R23.

Next, the operation in which the resistance value of the first resistor group 211 is controlled when the combination of the first to fourth test mode signals TM<1:4> is “H, H, L, and L” will be described below. For example, the combination “H, H, L, and L” of the first to fourth test mode signals TM<1:4> means that: the first test mode signal TM<1> is at a logic low level “L”; the second test mode signal TM<2> is at a logic low level “L”; the third test mode signal TM<3> is at a logic high level “H”; and the fourth test mode signal TM<4> is at a logic high level “H”.

With respect to the first resistor group 211, when, for example, the combination of the first to fourth test mode signals TM<1:4> is “H, H, L, and L”, the first switch N21 and the second switch N22 are turned off, and the third switch N23 and the fourth switch N24 are turned on. For example, the resistance value of the first resistor group 211 is set to 3 kΩ which is a sum of the resistance values of the first resistor R20 and second resistor R21.

The operations in which the resistance value of the first resistor group 211 is variously controlled according to a combination of the first to fourth test mode signals TM<1:4> could be easily derived by a person skilled in the art through the aforementioned examples, so a detailed description thereof will be omitted.

The second resistor group 212 may, for example, include: a fifth resistor R24 positioned between node nd25 and node nd26; a sixth resistor R25 positioned between node nd26 and node nd27; a seventh resistor R26 positioned between node nd27 and node nd28; an eighth resistor R28 positioned between node nd28 and a ground voltage VSS; a fifth switch N25 positioned between node nd25 and node nd26, and configured to be turned on and to electrically connect node nd25 and node nd26 to each other when the fourth test mode signal TM<4> is at a logic low level; a sixth switch N26 positioned between node nd26 and node nd27, and configured to be turned on and to electrically connect node nd26 and node nd27 to each other when the third test mode signal TM<3> is at a logic low level; a seventh switch N27 positioned between node nd27 and node nd28, and configured to be turned on and to electrically connect node nd27 and node nd28 to each other when the second test mode signal TM<2> is at a logic low level; and an eighth switch N28 positioned between node nd28 and the ground voltage VSS, and configured to be turned on and to electrically connect node nd28 and the ground voltage VSS to each other when the first test mode signal TM<1> is at a logic low level. For example, the fifth resistor R24 may be set to have a resistance value twice that of the sixth resistor R25, and the sixth resistor R25 may be set to have a resistance value twice that of the seventh resistor R26, and the seventh resistor R26 may be set to have a resistance value twice that of the eighth resistor R27. For example, the resistance values of the fifth to eighth resistors R24, R25, R26 and R27 have been set to two multiples for convenience of description, and it is preferred that the resistance values are set to integer multiples of one another.

The fifth to eighth switches N25, N26, N27 and N28 included in the second resistor group 212 may be configured with NMOS transistors, may be configured with PMOS transistors, or with a transmission gate in which NMOS and PMOS transistors are electrically connected according to embodiments.

For example, an example of an operation in which the resistance value of the second resistor group 212 is controlled according to a combination of the first to fourth test mode signals TM<1:4> will be described below, wherein the example will be described about the example where the resistance value of the eighth resistor R27 is set to 1 kΩ.

First, the operation in which the resistance value of the second resistor group 212 is controlled when the combination of the first to fourth test mode signals TM<1:4> is “L, L, H, and H” will be described below. For example, the combination “L, L, H, and H” of the first to fourth test mode signals TM<1:4> means that: the first test mode signal TM<1> is at a logic high level “H”; the second test mode signal TM<2> is at a logic high level “H”; the third test mode signal TM<3> is at a logic low level “L”; and the fourth test mode signal TM<4> is at a logic low level “L”.

With respect to the second resistor group 212, when, for example, the combination of the first to fourth test mode signals TM<1:4> is “L, L, H, and H”, the fifth switch N25 and the sixth switch N26 are turned on, and the seventh switch N27 and the eighth switch N28 are turned off. For example, the resistance value of the second resistor group 212 is set to 3 kΩ which is a sum of the resistance values of the seventh resistor R26 and eighth resistor R27.

Next, the operation in which the resistance value of the second resistor group 212 is controlled when the combination of the first to fourth test mode signals TM<1:4> is “H, H, L, and L” will be described below. For example, the combination “H, H, L, and L” of the first to fourth test mode signals TM<1:4> means that: the first test mode signal TM<1> is at a logic low level “L”; the second test mode signal TM<2> is at a logic low level “L”; the third test mode signal TM<3> is at a logic high level “H”; and the fourth test mode signal TM<4> is at a logic high level “H”.

With respect to the second resistor group 212, when, for example, the combination of the first to fourth test mode signals TM<1:4> is “H, H, L, and L”, the fifth switch N25 and the sixth switch N26 are turned off, and the seventh switch N27 and the eighth switch N28 are turned on. For example, the resistance value of the second resistor group 212 is set to 12 kΩ which is a sum of the resistance values of the fifth resistor R24 and sixth resistor R25.

The operations in which the resistance value of the second resistor group 212 is variously controlled according to a combination of the first to fourth test mode signals TM<1:4> could be easily derived by a person skilled in the art through the aforementioned examples, so a detailed description thereof will be omitted.

The third resistor group 213 may, for example, include: a ninth resistor R28 positioned between node nd24 and node nd29, through which the reference voltage VREF is outputted; and a tenth resistor R29 positioned between node nd29 and node nd25. For example, the third resistor group 213 is positioned between the first resistor group 211 and the second resistor group 212, and may generate a reference voltage VREF which is voltage-divided from the power supply voltage VDD by a difference of the resistance values between the first resistor group 211 and the second resistor group 212.

For example, the third resistor group 213 may be configured to include the ninth resistor R28 and the tenth resistor R29 connected in series to each other, or may be configured to include a plurality of resistors connected in series to each other. The resistance values of the ninth resistor R28 and tenth resistor R29 may be set to various values.

The reference voltage generation unit 21 may be configured to include the first to third resistor groups 211, 212 and 213, may be configured to include only the first resistor group 211 and the third resistor group 213, or may be configured to include only the second resistor group 212 and the third resistor group 213. Although the reference voltage generation unit 21 is configured to generate a reference voltage VREF controlled in 16 stages according to the first to fourth test mode signals TM<1:4>, the reference voltage generation unit 21 may be configured to generate a reference voltage VREF controlled in 2ⁿ levels according to the number “N” of bits of test mode signals.

With the operation of the semiconductor system configured as described above, the operation of controlling the level of a reference voltage VREF, which is controlled according to a difference of resistance values between the first resistor group 211 and the second resistor group 212 depending on a combination of the first to fourth test mode signals TM<1:4>, will be described below with reference to FIGS. 1 and 2, wherein the description will be given on the example where the resistance values of the eighth to tenth resistors R27, R28 and R29 are set to 1 kΩ.

First, the operation of controlling the level of the reference voltage VREF when, for example, the combination of the first to fourth test mode signals TM<1:4> is “L, L, H and H” is as follows. For example, the combination “L, L, H, and H” of the first to fourth test mode signals TM<1:4> means that: the first test mode signal TM<1> is at a logic high level “H”; the second test mode signal TM<2> is at a logic high level “H”; the third test mode signal TM<3> is at a logic low level “L”; and the fourth test mode signal TM<4> is at a logic low level “L”.

The controller 1 may count the first to fourth test mode signals TM<1:4>. The controller 1 may output the first to fourth test mode signals TM<1:4> as the combination “L, L, H, and H”, and outputs data DQ.

The first resistor group 211 of the reference voltage generation unit 21 may receive the first to fourth test mode signals TM<1:4>, so that the first switch N21 and second switch N22 are turned on, and the third switch N23 and fourth switch N24 are turned off. For example, the resistance value of the first resistor group 211 is set to 12 kΩ which is a sum of the resistance values of the third resistor R22 and fourth resistor R23.

The second resistor group 212 of the reference voltage generation unit 21 may receive the first to fourth test mode signals TM<1:4>, so that the fifth switch N25 and sixth switch N26 are turned on, and the seventh switch N27 and eighth switch N28 are turned off. For example, the resistance value of the second resistor group 212 is set to 3 kΩ which is a sum of the seventh resistor R26 and eighth resistor R27.

In the reference voltage generation unit 21, since the resistance value of the first resistor group 211 is 12 kΩ, the resistance value of the second resistor group 212 is 3 kΩ, and the resistance value of the third resistor group 213 is 2 kΩ, a reference voltage VREF as expressed in equation 1 below is generated according to the voltage divider rule.

$$\frac{( R 26 + R 27 ) + ( R 29 )}{( R 22 + R 23 ) + ( R 26 + R 27 ) + ( R 28 + R 29 )} ( VDD ) = \frac{3 K Ω + 1 K Ω}{12 K Ω + 3 K Ω + 2 K Ω} ( VDD ) = VREF \qquad ( 1 )$$

For example, the reference voltage generation unit 21 may generate a reference voltage VREF having a level of 4/17 of the power supply voltage VDD.

The data input/output unit 22 may compare data DQ with the reference voltage VREF having a level of 4/17 of the power supply voltage VDD, and may generate internal data ID.

The internal circuit 23 may be driven by receiving the reference voltage VREF, and may store the internal data ID.

Next, the operation of controlling the level of the reference voltage VREF when, for example, the combination of the first to fourth test mode signals TM<1:4> is “H, H, L and L” is as follows. For example, the combination “H, H, L, and L” of the first to fourth test mode signals TM<1:4> means that: the first test mode signal TM<1> is at a logic low level “L”; the second test mode signal TM<2> is at a logic low level “L”; the third test mode signal TM<3> is at a logic high level “H”; and the fourth test mode signal TM<4> is at a logic high level “H”.

The controller 1 may count the first to fourth test mode signals TM<1:4>. The controller 1 may output the first to fourth test mode signals TM<1:4> as the combination “H, H, L, and L”, and may output data DQ.

The first resistor group 211 of the reference voltage generation unit 21 receives the first to fourth test mode signals TM<1:4>, so that the first switch N21 and second switch N22 are turned off, and the third switch N23 and fourth switch N24 are turned on. For example, the resistance value of the first resistor group 211 is set to 3 kΩ which is a sum of the resistance values of the first resistor R20 and second resistor R21.

The second resistor group 212 of the reference voltage generation unit 21 may receive the first to fourth test mode signals TM<1:4>, so that the fifth switch N25 and sixth switch N26 are turned off, and the seventh switch N27 and eighth switch N28 are turned on. For example, the resistance value of the second resistor group 212 is set to 12 kΩ which is a sum of the fifth resistor R24 and sixth resistor R25.

In the reference voltage generation unit 21, since the resistance value of the first resistor group 211 is 3 kΩ, the resistance value of the second resistor group 212 is 12 kΩ, and the resistance value of the third resistor group 213 is 2 kΩ, a reference voltage VREF as expressed in equation 2 below is generated according to the voltage divider rule.

$$\frac{( R 24 + R 25 ) + ( R 29 )}{( R 20 + R 21 ) + ( R 24 + R 25 ) + ( R 28 + R 29 )} ( VDD ) = \frac{12 K Ω + 1 K Ω}{3 K Ω + 12 K Ω + 2 K Ω} ( VDD ) = VREF \qquad ( 2 )$$

For example, the reference voltage generation unit 21 may generate a reference voltage VREF having a level of 13/17 of the power supply voltage VDD.

The data input/output unit 22 may compare data DQ with the reference voltage VREF having a level of 13/17 of the power supply voltage VDD, and may generate internal data ID.

The internal circuit 23 may be driven by receiving the reference voltage VREF, and may store the internal data ID.

The semiconductor system configured as above controls, for example, the level of the reference voltage VREF in 16 stages according to a combination of the counted first to fourth test mode signals TM<1:4>, and thus can variously control the level of the reference voltage VREF.

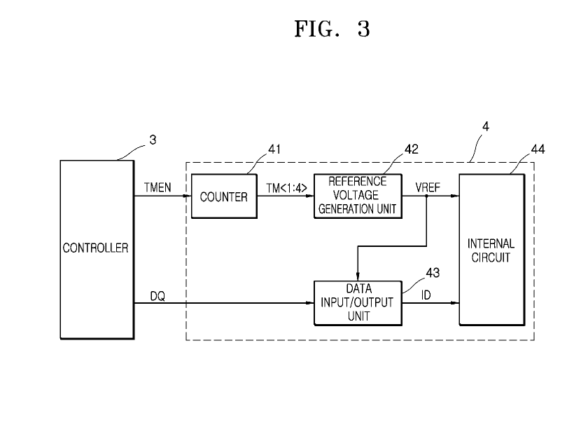

FIG. 3 is a block diagram illustrating a representation of an example of the configuration of a semiconductor system in accordance with an embodiment.

Referring to FIG. 3, in accordance with an embodiment, a semiconductor system may include a controller 3 and a voltage level control circuit 4. The voltage level control circuit 4 may include a counter 41, and a reference voltage generation unit 42. The voltage level control circuit 4 may include a data input/output unit 43, and an internal circuit 44.

The controller 3 may output a test enable signal TMEN and data DQ.

The counter 41 may count first to fourth test mode signals TM<1:4> by the number of received test enable signals TMEN.

Referring to FIGS. 2 and 3, the reference voltage generation unit 42 may include the first resistor group 211 and second resistor group 212. The first and second resistor groups 211 and 212 may include resistors having integer multiples of resistances, may be connected in series to each other, and may generate a reference voltage VREF. The reference voltage VREF may include a voltage-divided from the power supply voltage VDD by the resistance values of the first resistor group 211 and second resistor group 212 controlled according to a combination of the first to fourth test mode signals TM<1:4>.

For example, the reference voltage generation unit 42 may be configured with the same circuit as the reference voltage generation unit 21 illustrated in FIG. 2, so a detailed description thereof will be omitted.

The reference voltage generation unit 42 is configured, for example, to generate a reference voltage VREF controlled in 16 stages according to the first to fourth test mode signals TM<1:4>, or may be configured to generate a reference voltage VREF controlled in 2ⁿ levels according to the number “N” of bits of test mode signals.

The data input/output unit 43 may compare data DQ with the reference voltage VREF and generate internal data ID. For example, the data input/output unit 43 may be configured with a comparator having the form of a differential amplifier. For example, although the data input/output unit 43 is configured to compare data DQ with the reference voltage VREF to generate internal data ID, or may be configured to compare internal data ID with the reference voltage VREF to generate data DQ.

The internal circuit 44 may be driven by receiving the reference voltage VREF, and store internal data ID. For example, the internal circuit 44 may be implemented with a general circuit driven by receiving the reference voltage VREF. For example, although the internal circuit 44 is configured to store internal data ID, the internal circuit 44 may be configured to output internal data ID.

The semiconductor system configured as above may control, for example, the level of the reference voltage VREF in 16 stages according to a combination of the counted first to fourth test mode signals TM<1:4>, and thus can variously control the level of the reference voltage VREF.

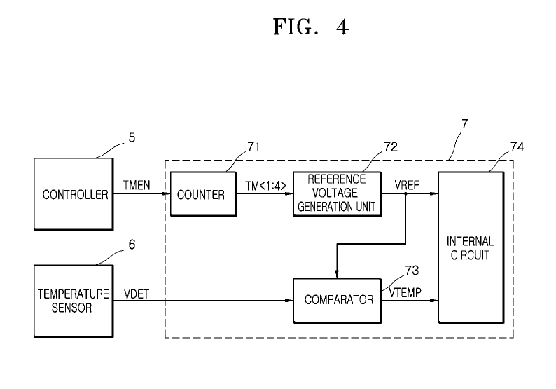

FIG. 4 is a block diagram illustrating a representation of an example of the configuration of a semiconductor system in accordance with an embodiment.

Referring to FIG. 4, in accordance with an embodiment, a semiconductor system may include a controller 5, a temperature sensor 6, and a voltage level control circuit 7. The voltage level control circuit 7 may include a counter 71, and a reference voltage generation unit 72. The voltage level control circuit 7 may include a comparator 73, and an internal circuit 74.

The controller 5 may output a test enable signal TMEN.

The temperature sensor 6 may detect an internal temperature and may generate a temperature detection voltage VDET. For example, the temperature detection voltage VDET may be generated to have a voltage level. The voltage level of the temperature detection voltage VDET may increase or decrease depending on a change in the internal temperature.

The counter 71 may count first to fourth test mode signals TM<1:4> by the number of received test enable signals TMEN.

Referring to FIGS. 2 and 4, the reference voltage generation unit 72 may include the first resistor group 211 and second resistor group 212. The first and second resistor groups 211 and 212 may include resistors having integer multiples of resistances, may be connected in series to each other, and may generate a reference voltage VREF. The reference voltage VREF may include a voltage-divided from the power supply voltage VDD by the resistance values of the first resistor group 211 and second resistor group 212 controlled according to a combination of the first to fourth test mode signals TM<1:4>.

For example, the reference voltage generation unit 72 may be configured with the same circuit as the reference voltage generation unit 21 illustrated in FIG. 2, so a detailed description thereof will be omitted.

The reference voltage generation unit 72 is configured, for example, to generate a reference voltage VREF which is controlled in 16 stages according to the first to fourth test mode signals TM<1:4>, or may be configured to generate a reference voltage VREF which is controlled in 2ⁿ levels according to the number “N” of bits of test mode signals.

The comparator 73 may compare the temperature detection voltage VDET with the reference voltage VREF. The comparator 73 may generate a temperature voltage VTEMP including information on the internal temperature of the semiconductor system. For example, the comparator 73 may be configured with a comparator having the form of a differential amplifier. For example, the comparator 73 may be configured to compare a temperature detection voltage VDET with the reference voltage VREF, and to generate the temperature voltage VTEMP, or the comparator 73 may be configured to compare the temperature detection voltage VDET with the reference voltage VREF, and to generate a plurality of temperature codes including internal temperature information.

The internal circuit 74 may be driven by receiving the reference voltage VREF and temperature voltage VTEMP. For example, the internal circuit 74 may be implemented with a general circuit driven by receiving the reference voltage VREF.

The semiconductor system configured as above may control, for example, the level of the reference voltage VREF in 16 stages according to a combination of the counted first to fourth test mode signals TM<1:4>, and thus can variously control the level of the reference voltage VREF.

According to the embodiments, the level of a reference voltage can be variously controlled according to a combination of test mode signals.

The semiconductor system and/or voltage level control circuit discussed above (see FIGS. 1-4) are particular useful in the design of memory devices, processors, and computer systems. For example, referring to FIG. 6, a block diagram of a system employing the semiconductor system and/or voltage level control circuit in accordance with the various embodiments are illustrated and generally designated by a reference numeral 1000. The system 1000 may include one or more processors or central processing units (“CPUs”) 1100. The CPU 1100 may be used individually or in combination with other CPUs. While the CPU 1100 will be referred to primarily in the singular, it will be understood by those skilled in the art that a system with any number of physical or logical CPUs may be implemented.

A chipset 1150 may be operably coupled to the CPU 1100. The chipset 1150 is a communication pathway for signals between the CPU 1100 and other components of the system 1000, which may include a memory controller 1200, an input/output (“I/O”) bus 1250, and a disk drive controller 1300. Depending on the configuration of the system, any one of a number of different signals may be transmitted through the chipset 1150, and those skilled in the art will appreciate that the routing of the signals throughout the system 1000 can be readily adjusted without changing the underlying nature of the system.

As stated above, the memory controller 1200 may be operably coupled to the chipset 1150. The memory controller 1200 may include at least one semiconductor system and/or voltage level control circuit as discussed above with reference to FIGS. 1-4. Thus, the memory controller 1200 can receive a request provided from the CPU 1100, through the chipset 1150. In alternate embodiments, the memory controller 1200 may be integrated into the chipset 1150. The memory controller 1200 may be operably coupled to one or more memory devices 1350. In an embodiment, the memory devices 1350 may include the at least one semiconductor system and/or voltage level control circuit as discussed above with relation to FIGS. 1-4, the memory devices 1350 may include a plurality of word lines and a plurality of bit lines for defining a plurality of memory cells. The memory devices 1350 may be any one of a number of industry standard memory types, including but not limited to, single inline memory modules (“SIMMs”) and dual inline memory modules (“DIMMs”). Further, the memory devices 1350 may facilitate the safe removal of the external data storage devices by storing both instructions and data.

The chipset 1150 may also be coupled to the I/O bus 1250. The I/O bus 1250 may serve as a communication pathway for signals from the chipset 1150 to I/O devices 1410, 1420 and 1430. The I/O devices 1410, 1420 and 1430 may include a mouse 1410, a video display 1420, or a keyboard 1430. The I/O bus 1250 may employ any one of a number of communications protocols to communicate with the I/O devices 1410, 1420, and 1430. Further, the I/O bus 1250 may be integrated into the chipset 1150.

The disk drive controller 1450 (i.e., internal disk drive) may also be operably coupled to the chipset 1150. The disk drive controller 1450 may serve as the communication pathway between the chipset 1150 and one or more internal disk drives 1450. The internal disk drive 1450 may facilitate disconnection of the external data storage devices by storing both instructions and data. The disk drive controller 1300 and the internal disk drives 1450 may communicate with each other or with the chipset 1150 using virtually any type of communication protocol, including all of those mentioned above with regard to the I/O bus 1250.

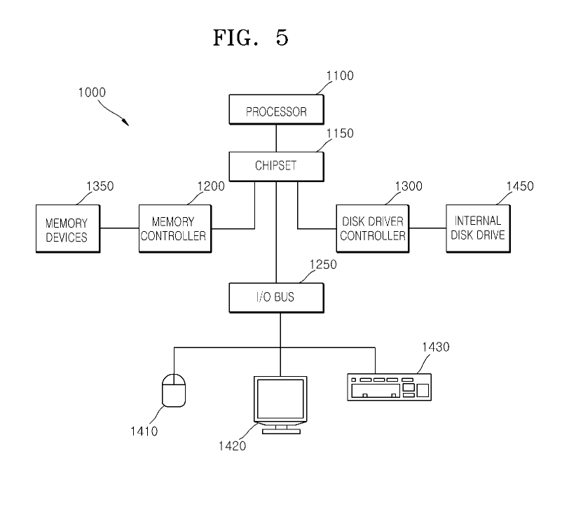

It is important to note that the system 1000 described above in relation to FIG. 5 is merely one example of a system employing the semiconductor system and/or voltage level control circuit as discussed above with relation to FIGS. 1-4. In alternate embodiments, such as cellular phones or digital cameras, the components may differ from the embodiments illustrated in FIG. 5.

While various embodiments have been described above, it will be understood to those skilled in the art that the embodiments described are by way of example only. Accordingly, the circuit and system described herein should not be limited based on the described embodiments.

What is claimed is:

1. A semiconductor system comprising:
a controller configured to output data and first and second test mode signals; and
a voltage level control circuit configured to include a resistor group, and to compare the data with a reference voltage to generate internal data,
wherein resistors of the resistor group having integer multiples of resistances are connected in series to generate the reference voltage, the reference voltage voltage-divided from a power supply voltage by a resistance value of the resistor group controlled according to a combination of the first and second test mode signals.

2. The system of claim 1, wherein the voltage level control circuit comprises:
a reference voltage generation unit configured to generate the reference voltage, a level of the reference voltage is controlled by a resistance value controlled according to a combination of the first and second test mode signals;
a data input/output unit configured to compare the data with the reference voltage and to generate the internal data; and
an internal circuit configured to be supplied with the reference voltage, to be driven, and to store the internal data.

3. The system of claim 2, wherein the reference voltage generation unit comprises:
a first resistor group configured to include first and second resistors selected in response to the first and second test mode signals;
a second resistor group configured to include third and fourth resistors selected in response to the first and second test mode signals; and
a third resistor group electrically coupled between the first resistor group and the second resistor group, and configured to generate the reference voltage according to resistance values of the first and second resistor groups.

4. The system of claim 3, wherein the first resistor group comprises:
the first resistor electrically coupled between the power supply voltage and a first node;
the second resistor electrically coupled between the first node and a second node;
a first switch coupled between the power supply voltage and the first node, and configured to electrically connect the power supply voltage to the first node in response to the first test mode signal; and
a second switch coupled between the first node and the second node, and configured to electrically connect the first node to the second node in response to the second test mode signal,
wherein the resistance values of the first and second resistors are set to integer multiples of one another.

5. The system of claim 3, wherein the second resistor group comprises:
the third resistor electrically coupled between a third node and a fourth node;
the fourth resistor electrically coupled between the fourth node and a ground voltage;
a third switch coupled between the third node and the fourth node, and configured to electrically connect the third node to the fourth node in response to the second test mode signal; and
a fourth switch coupled between the fourth node and the ground voltage, and configured to electrically connect the fourth node to the ground voltage in response to the first test mode signal,
wherein the resistance values of the third and fourth resistors are set to integer multiples of one another.

6. A semiconductor system comprising:
a controller configured to output a test enable signal and data; and
a voltage level control circuit configured to include a resistor group, the resistor group including resistors connected in series and having integer multiples of resistances, to generate a reference voltage, the reference voltage voltage-divided from a power supply voltage by a resistance value of the resistor group controlled by the number of input times of the test enable signal to the voltage level control circuit, and to compare the data with the reference voltage to generate internal data.

7. The system of claim 6, wherein the voltage level control circuit comprises:
a counter configured to generate first and second test mode signals, the counter configured to count the output of the first and second test mode signals in response to the test enable signal;
a reference voltage generation unit configured to generate the reference voltage, a level of the reference voltage is controlled by a resistance value controlled according to a combination of the first and second test mode signals;
a data input/output unit configured to compare the data with the reference voltage and to generate the internal data; and
an internal circuit configured to be supplied with the reference voltage, to be driven, and to store the internal data.

8. The system of claim 7, wherein the reference voltage generation unit comprises:
a first resistor group configured to include first and second resistors selected in response to the first and second test mode signals;
a second resistor group configured to include third and fourth resistors selected in response to the first and second test mode signals; and
a third resistor group electrically coupled between the first resistor group and the second resistor group, and configured to generate the reference voltage according to resistance values of the first and second resistor groups.

9. The system of claim 8, wherein the first resistor group comprises:
the first resistor electrically coupled between the power supply voltage and a first node;
the second resistor electrically coupled between the first node and a second node;
a first switch coupled between the power supply voltage and the first node, and configured to electrically connect the power supply voltage to the first node in response to the first test mode signal; and
a second switch coupled between the first node and the second node, and configured to electrically connect the first node to the second node in response to the second test mode signal,
wherein the resistance values of the first and second resistors are set to integer multiples of one another.

10. The system of claim 8, wherein the second resistor group comprises:
the third resistor electrically coupled between a third node and a fourth node;
the fourth resistor electrically coupled between the fourth node and a ground voltage;
a third switch coupled between the third node and the fourth node, and configured to electrically connect the third node to the fourth node in response to the second test mode signal; and
a fourth switch coupled between the fourth node and the ground voltage, and configured to electrically connect the fourth node to the ground voltage in response to the first test mode signal,
wherein the resistance values of the third and fourth resistors are set to integer multiples of one another.

11. A semiconductor system comprising:
a controller configured to output a test enable signal;
a temperature sensor configured to detect an internal temperature and to generate a temperature detection voltage; and
a voltage level control circuit configured to include a resistor group, the resistor group including resistors connected in series and having integer multiples of resistances, to generate a reference voltage, the reference voltage voltage-divided from a power supply voltage by a resistance value of the resistor group controlled by the number of input times of the test enable signal to the voltage level control circuit, and to compare the temperature detection voltage with the reference voltage to generate a temperature voltage.

12. The system of claim 11, wherein the voltage level control circuit comprises:
a counter configured to generate first and second test mode signals, the counter configured to count the output of the first and second test mode signals in response to the test enable signal;
a reference voltage generation unit configured to generate the reference voltage, a level of the reference voltage is controlled by a resistance value controlled according to a combination of the first and second test mode signals; and
a comparator configured to compare the data with the reference voltage and to generate the temperature voltage.

13. The system of claim 12, wherein the reference voltage generation unit comprises:
a first resistor group configured to include first and second resistors selected in response to the first and second test mode signals;
a second resistor group configured to include third and fourth resistors selected in response to the first and second test mode signals; and
a third resistor group electrically coupled between the first resistor group and the second resistor group, and configured to generate the reference voltage according to resistance values of the first and second resistor groups.

14. The system of claim 13, wherein the first resistor group comprises:
the first resistor electrically coupled between the power supply voltage and a first node;
the second resistor electrically coupled between the first node and a second node;
a first switch coupled between the power supply voltage and the first node, and configured to electrically connect the power supply voltage to the first node in response to the first test mode signal; and
a second switch coupled between the first node and the second node, and configured to electrically connect the first node to the second node in response to the second test mode signal,
wherein the resistance values of the first and second resistors are set to integer multiples of one another.

15. The system of claim 13, wherein the second resistor group comprises:
the third resistor electrically coupled between a third node and a fourth node;
the fourth resistor electrically coupled between the fourth node and a ground voltage;
a third switch coupled between the third node and the fourth node, and configured to electrically connect the third node to the fourth node in response to the second test mode signal; and
a fourth switch coupled between the fourth node and the ground voltage, and configured to electrically connect the fourth node to the ground voltage in response to the first test mode signal,
wherein the resistance values of the third and fourth resistors are set to integer multiples of one another.

16. A voltage level control circuit comprising:
a reference voltage generation unit configured to include a resistor group, the resistor group including resistors connected in series and having integer multiples of resistances, and to generate a reference voltage, the reference voltage voltage-divided from a power supply voltage by a resistance value of the resistor group controlled according to a combination of first and second test mode signals;
a data input/output unit configured to compare the data with the reference voltage and to generate internal data; and
an internal circuit configured to be supplied with the reference voltage, to be driven, and to store the internal data.

17. The circuit of claim 16, wherein the reference voltage generation unit comprises:
a first resistor group configured to include first and second resistors selected in response to the first and second test mode signals;
a second resistor group configured to include third and fourth resistors selected in response to the first and second test mode signals; and
a third resistor group electrically coupled between the first resistor group and the second resistor group, and configured to generate the reference voltage according to resistance values of the first and second resistor groups.

18. The circuit of claim 17, wherein the first resistor group comprises:
the first resistor electrically coupled between the power supply voltage and a first node;
the second resistor electrically coupled between the first node and a second node;
a first switch coupled between the power supply voltage and the first node, and configured to electrically connect the power supply voltage to the first node in response to the first test mode signal; and
a second switch coupled between the first node and the second node, and configured to electrically connect the first node to the second node in response to the second test mode signal,
wherein the resistance values of the first and second resistors are set to integer multiples of one another.

19. The circuit of claim 17, wherein the second resistor group comprises:
the third resistor electrically coupled between a third node and a fourth node;
the fourth resistor electrically coupled between the fourth node and a ground voltage;
a third switch coupled between the third node and the fourth node, and configured to electrically connect the third node to the fourth node in response to the second test mode signal; and
a fourth switch coupled between the fourth node and the ground voltage, and configured to electrically connect the fourth node to the ground voltage in response to the first test mode signal,
wherein the resistance values of the third and fourth resistors are set to integer multiples of one another.

20. The circuit of claim 16, further comprising a counter configured to count the first and second test mode signals in response to a test enable signal received from an exterior.
